(19) United States
(12) Patent Application Publication
(10) Pub. No.: US 2021/0287461 A1
(43) Pub. Date: Sep. 16, 2021

(54) VEHICLE INSPECTION SYSTEM

(71) Applicant: HONDA MOTOR CO., LTD., Minato-ku, Tokyo (JP)

(72) Inventor: Shoji Matsuda, Haga-gun, Tochigi-ken (JP)

(21) Appl. No.: 17/277,310

(22) PCT Filed: Sep. 2, 2019
(86) PCT No.: PCT/JP2019/034426

§ 371 Date: Mar. 18, 2021

(30) Foreign Application Priority Data
Sep. 21, 2018 (JP) 2018-178005

(51) Int. Cl. G07C 5/08; G07C 5/00; B60W 30/12; B60W 30/09

(52) U.S. Cl. CPC G07C 5/0825; G07C 5/008; B60W 2420/52; B60W 30/09; B60W 2420/42; B60W 30/12

(57) ABSTRACT

Provided is a vehicle inspection system with which an inspection of various functions of a vehicle can be conducted in a small space on the basis of image information of a plurality of cameras. The present invention is a vehicle inspection system for inspecting a vehicle in which a travel control is executed on the basis of external environment information in a prescribed direction detected by a first single-lens camera and a second single-lens camera, wherein said vehicle inspection system comprises a 3-D display device which shows a first image imitating an external environment to the first single-lens camera and also shows a second image imitating the external environment to the second single-lens camera, and furthermore, shows the first image and the second image on the same screen.

### TECHNICAL FIELD

The present invention relates to a vehicle inspection system for inspecting a vehicle that performs travel control on the basis of external environment information detected by a first monocular camera and a second monocular camera.

### Background Art

Japanese Laid-Open Patent Publication No. 2018-096958 discloses a system in which a driving function of a vehicle that performs automated driving with the use of a camera, a radar, a LiDAR, and a GPS receiver is inspected indoors. In this system, the automated driving function (driving assistance function) is inspected with the vehicle mounted on a bench test machine. For example, the system checks whether the vehicle travels properly to a destination in a state where the destination is set in a navigation device of the vehicle by transmitting a quasi-signal indicating a vehicle position to the GPS receiver. Moreover, the system checks whether the vehicle brakes properly by causing the camera of the vehicle to photograph a quasi-traffic signal while the vehicle is in a traveling state.

### SUMMARY OF INVENTION

A vehicle system in which two cameras (monocular cameras) that are adjacent to each other photograph an external environment in the same direction in order to achieve the redundancy or the like has been studied. In a such vehicle system, it is necessary that the external environment that is recognized based on a photographing result from one camera is the same as the external environment that is recognized based on a photographing result from the other camera. In the system disclosed in Japanese Laid-Open Patent Publication No. 2018-096958, a vehicle system in which a plurality of cameras photograph an external environment in the same direction is not considered. Moreover, when the vehicle is inspected, a large inspection space is required in order to make photographing results from the plurality of cameras the same.

The present invention has been made in view of such a circumstance, and an object of the present invention is to provide a vehicle inspection system that can inspect various functions of a vehicle on the basis of image information from a plurality of cameras, with space saved.

An aspect of the present invention is a vehicle inspection system configured to inspect a vehicle that performs travel control on the basis of information about an external environment in a predetermined direction, detected by a first monocular camera and a second monocular camera, the vehicle inspection system including a three-dimensional display device configured to display a first image simulating the external environment toward the first monocular camera, display a second image simulating the external environment toward the second monocular camera, and moreover display the first image and the second image in the same screen.

According to the present invention, images simulating various external environments can be shown, in the same screen, toward the first monocular camera and the second monocular camera of the vehicle. Thus, various functions of the vehicle on the basis of image information can be inspected with space saved.

### BRIEF DESCRIPTION OF DRAWINGS

FIG. 1 is a device structure diagram of a vehicle to be inspected in an embodiment;

FIG. 2 is a system structure diagram of a vehicle inspection system according to the embodiment;

FIG. 3 is a schematic diagram of a roller unit;

FIG. 4A, FIG. 4B, and FIG. 4C are schematic diagrams of a three-dimensional display device;

FIG. 5 is a flowchart illustrating a procedure of inspecting the vehicle;

FIG. 6A and FIG. 6B are diagrams for describing positioning of a front wheel;

FIG. 7A, FIG. 7B, and FIG. 7C are diagrams for describing a virtual external environment displayed on the three-dimensional display device; and

FIG. 8A, FIG. 8B, and FIG. 8C are diagrams for describing a state in which a two-dimensional display device is photographed by two monocular cameras.

### DESCRIPTION OF EMBODIMENT

A preferred embodiment of a vehicle inspection system according to the present invention is hereinafter described in detail with reference to the attached drawings.

### 1. Vehicle 200

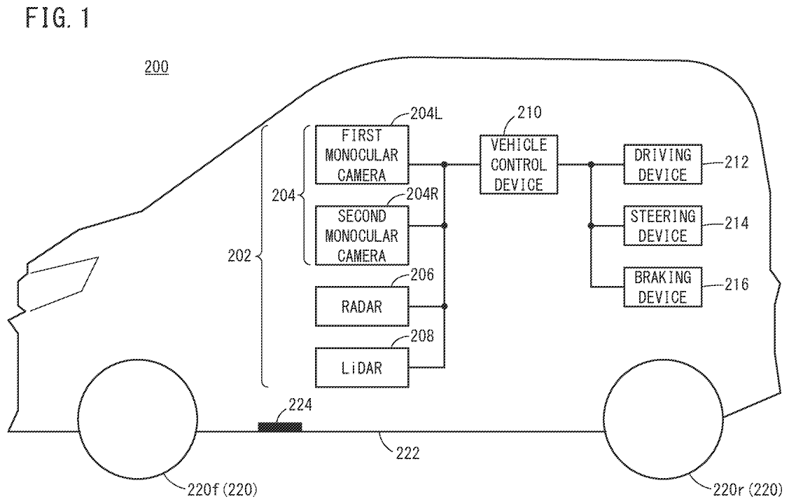

A vehicle 200 to be inspected in the present embodiment is described with reference to FIG. 1. Here, it is assumed that the vehicle 200 is a driving assistance vehicle capable of automatic control of at least one of acceleration/deceleration, braking, and steering on the basis of detection information from external environment sensors 202. Note that the vehicle 200 may be an automated driving vehicle (including fully automated driving vehicle) capable of the automatic control of the acceleration/deceleration, the braking, and the steering on the basis of the detection information from the external environment sensors 202 and positional information of GNSS (not illustrated). As illustrated in FIG. 1, the vehicle 200 includes the external environment sensors 202 that detect external environment information, a vehicle control device 210 that performs travel control of the vehicle 200, a driving device 212, a steering device 214, and a braking device 216 that operate in accordance with an operation instruction output from the vehicle control device 210, and each wheel 220.

The external environment sensors 202 include a camera group 204, one or more radars 206, and one or more LiDARs 208 for detecting the external environment information ahead of the vehicle 200. The camera group 204 includes a first monocular camera 204L and a second monocular camera 204R. The first monocular camera 204L and the second monocular camera 204R are provided to achieve the redundancy in external environment recognition, and disposed near a rearview mirror and arranged side by side along a vehicle width direction. The first monocular camera 204L and the second monocular camera 204R photograph an external environment ahead of the vehicle 200. The radar 206 emits an electric wave ahead of the vehicle 200, and detects a reflection wave reflected in the external environment. The

LiDAR 208 emits laser light ahead of the vehicle 200, and detects scattering light scattering in the external environment. Note that the description about the external environment sensor that detects the external environment information other than the information about the environment ahead of the vehicle 200 is omitted.

The vehicle control device 210 is formed by a vehicle control ECU. On the basis of first image information from the first monocular camera 204L, second image information from the second monocular camera 204R, and the detection information from the radar 206 and the LiDAR 208, the vehicle control device 210 calculates the optimum acceleration/deceleration, braking quantity, and steering angle in accordance with various kinds of driving assistance functions (for example, lane keeping function, inter-vehicle distance maintenance function, collision mitigation brake function, etc.), and outputs the operation instruction to various kinds of control target devices.

The driving device 212 includes a driving ECU, and a driving source such as an engine or a traction motor. The driving device 212 generates the driving force for the wheels 220 in accordance with the occupant's operation on an accelerator pedal or the operation instruction output from the vehicle control device 210. The steering device 214 includes an electric power steering system (EPS) ECU and an EPS actuator. The steering device 214 changes a steering angle θs of the wheels 220 (front wheels 220f) in accordance with the occupant's operation of a steering wheel or the operation instruction output from the vehicle control device 210. The braking device 216 includes a brake ECU and a brake actuator. The braking device 216 generates the braking force for the wheels 220 in accordance with the occupant's operation on a brake pedal or the operation instruction output from the vehicle control device 210. On a bottom surface 222 of the vehicle 200, a jack-up point 224 exists.

### 2. Vehicle Inspection System 10

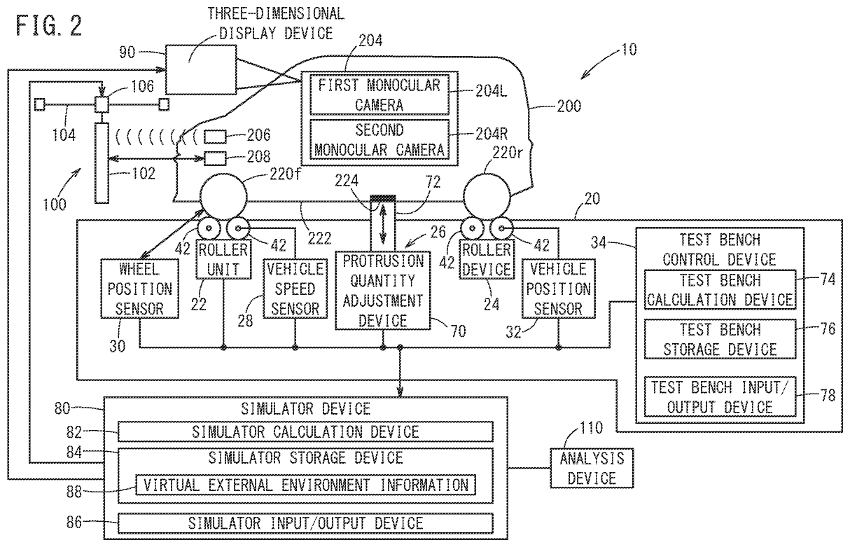

A vehicle inspection system 10 that inspects operation of the vehicle 200 is described with reference to FIG. 2. The vehicle inspection system 10 includes a bench test machine 20, a simulator device 80, a three-dimensional display device 90, a target device 100, and an analysis device 110.

### [2.1. Bench Test Machine 20]

As illustrated in FIG. 2, the bench test machine 20 includes a roller unit 22, a roller device 24, a movement restriction device 26, a vehicle speed sensor 28, a wheel position sensor 30, a vehicle position sensor 32, and a test bench control device 34. The bench test machine 20 for inspecting the vehicle 200 whose front wheels 220f are drive wheels and steered wheels is described below.

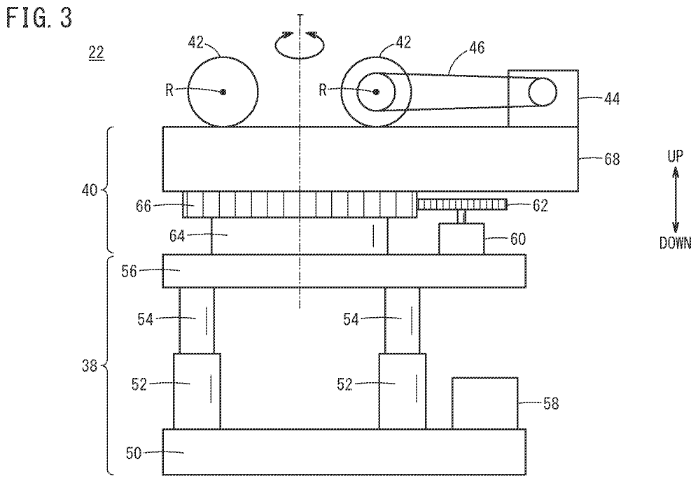

The roller unit 22 is a mechanism that is provided below the front wheel 220f of the vehicle 200 placed on the bench test machine 20, and rotatably and turnably supports the front wheel 220f. As illustrated in FIG. 3, the roller unit 22 includes a lifting mechanism 38, a turning mechanism 40, and two rollers 42. The roller unit 22 can turn the two rollers 42 around a turning axis T, which is parallel to an up and down direction, so as to follow up steering operation of the front wheel 220f, and moreover can lift the two rollers 42 in the up and down direction.

The lifting mechanism 38 includes a base 50, a plurality of cylinders 52, a plurality of pistons 54, a lifting board 56, and a height adjustment device 58. The base 50 is positioned at a lowermost part of the roller unit 22, and is fixed to a main body of the bench test machine 20. The cylinder 52 is a fluid pressure cylinder (pneumatic cylinder or hydraulic cylinder) and is fixed to the base 50. The piston 54 goes up in an up direction when a fluid is supplied to the cylinder 52, and goes down in a down direction when the fluid is discharged from the cylinder 52. The lifting board 56 is supported by the pistons 54 from below, and goes up and down in accordance with the operation of the pistons 54. The height adjustment device 58 is a device (for example, pump, pipe, or solenoid valve) that supplies the fluid to the cylinder 52 and discharges the fluid from the cylinder 52. The solenoid valve of the height adjustment device 58 operates in accordance with a pilot signal output from the test bench control device 34. The supplying and discharging of the fluid to and from the cylinder 52 are switched in accordance with the operation of the solenoid valve. Note that the lifting mechanism 38 may be operated by an electric motor instead of by fluid pressure. Note that the supporting by the piston 54 may be assisted by a stopper that is not illustrated.

The turning mechanism 40 includes a turning motor 60, a first gear 62, a supporting board 64, a second gear 66, and a turning table 68. The turning motor 60 is fixed to the lifting board 56. The first gear 62 is fixed to an output shaft of the turning motor 60. The turning motor 60 operates with the electric power supplied from the test bench control device 34. The supporting board 64 is fixed to an upper surface of the lifting board 56. The second gear 66 is supported by the supporting board 64 so as to be rotatable around the turning axis T that is parallel to the up and down direction. In addition, teeth formed on a circumferential surface of the second gear 66 mesh with teeth formed on a circumferential surface of the first gear 62. The turning table 68 is attached to an upper surface of the second gear 66, and turns around the turning axis T together with the rotation of the second gear 66.

The two rollers 42 are supported by the turning table 68 in a state of being rotatable around a rotation axis R, which is parallel to a horizontal plane. One of the two rollers 42 is in contact with a lower front surface of the front wheel 220f and the other thereof is in contact with a lower rear surface of the front wheel 220f; thus, the front wheel 220f is rotatably supported. When the steering angle θs of the front wheel 220f is zero, the axial direction of the two rollers 42 is parallel to the vehicle width direction. One of the two rollers 42 is connected to an output shaft of a torque motor 44 through a belt 46. The torque motor 44 can apply a virtual load on the wheel 220 by applying, to the rollers 42, a torque around the rotation axis R. The torque motor 44 operates with the electric power supplied from the test bench control device 34.

Back to FIG. 2, the description of the bench test machine 20 is continued. The roller device 24 is a mechanism that is provided below a rear wheel 220r of the vehicle 200 placed on the bench test machine 20, and rotatably supports the rear wheel 220r. The roller device 24 includes two rollers 42. The two rollers 42 are rotatably supported using the rotation axis R, which is parallel to the axial direction, as a center.

The movement restriction device 26 is a mechanism that is disposed below the vehicle 200 in a state of being placed on the bench test machine 20, and restricts the movement of the vehicle 200 in the vehicle width direction. The movement restriction device 26 includes a convex part 72 and a protrusion quantity adjustment device 70. The convex part 72 is a piston itself or a member connected to the piston, which makes contact with the jack-up point 224. The protrusion quantity adjustment device 70 is a fluid pressure cylinder, a fluid pressure pump, a pipe, a solenoid valve, and the like, for operating the piston. Alternatively, the convex part 72 may be a rack itself or a member connected to the rack, and the protrusion quantity adjustment device 70 may be a pinion, an electric motor, or the like, for operating the rack. The movement restriction device 26 changes the upward protrusion quantity of the convex part 72 by the operation of the protrusion quantity adjustment device 70. The protrusion quantity adjustment device 70 operates in accordance with an operation instruction output from the test bench control device 34. In a state where the front wheel 220f is placed on the roller unit 22 and the rear wheel 220r is placed on the roller device 24, the convex part 72 is placed right below the jack-up point 224. Note that when the vehicle 200 is advanced onto the bench test machine 20, the convex part 72 is housed lower than an upper surface of the bench test machine 20.

The vehicle speed sensor 28 is formed by, for example, a rotary encoder or a resolver. The vehicle speed sensor 28 detects rotation speed r of any of the rollers 42 in the roller unit 22. The rotation speed r corresponds to vehicle speed V. The wheel position sensor 30 is formed by a laser ranging device or the like. The wheel position sensor 30 detects a distance d from the wheel position sensor 30 to a predetermined portion of the front wheel 220f. The distance d corresponds to the steering angle θs of the vehicle 200. The vehicle position sensor 32 is formed by a laser ranging device or the like. The vehicle position sensor 32 detects a distance D from the vehicle position sensor 32 to a predetermined portion (side portion) of the vehicle 200. The distance D corresponds to a position of the vehicle 200 in the vehicle width direction.

The test bench control device 34 is formed by a computer, and includes a test bench calculation device 74, a test bench storage device 76, and a test bench input/output device 78. The test bench calculation device 74 is formed by a processor such as a CPU. The test bench calculation device 74 controls the height adjustment device 58, the turning motor 60, and the torque motor 44 in the roller unit 22 by executing programs stored in the test bench storage device 76. The test bench storage device 76 is formed by a ROM, a RAM, a hard disk, and the like. The test bench input/output device 78 includes an A/D conversion circuit, a communication interface, a driver, and the like.

### [2.2. Simulator Device 80]

In a manner similar to the test bench control device 34, the simulator device 80 is formed by a computer, and includes a simulator calculation device 82, a simulator storage device 84, and a simulator input/output device 86. The simulator calculation device 82 is formed by a processor such as a CPU. The simulator calculation device 82 executes programs stored in the simulator storage device 84 so as to output image information about a virtual external environment to the three-dimensional display device 90. The simulator storage device 84 is formed by a ROM, a RAM, a hard disk, and the like. The simulator storage device 84 stores programs that are executed by the simulator calculation device 82, and virtual external environment information 88 simulating the external environment information. The virtual external environment information 88 is information to reproduce a series of virtual external environments, and the information about the initial position of the vehicle 200 in the virtual external environment, the position of each object in the virtual external environment, the behavior of the moving object, or the like is set in advance. The simulator input/output device 86 includes an A/D conversion circuit, a communication interface, a driver, and the like.

### [2.3. Three-Dimensional Display Device 90]

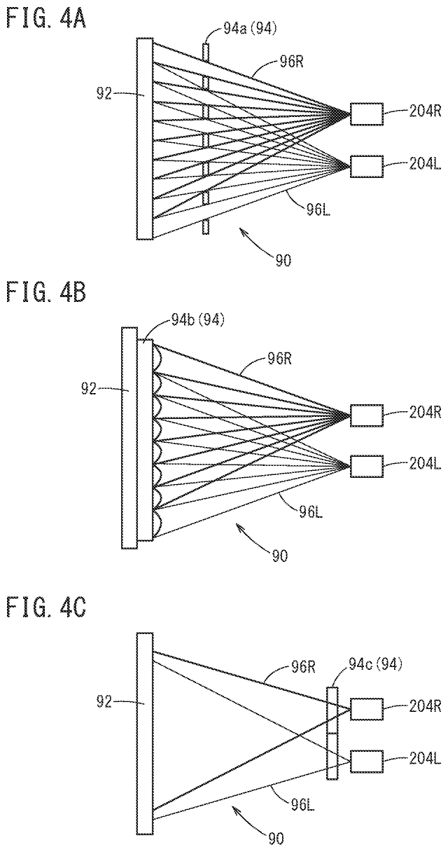

The three-dimensional display device 90 is disposed so as to face a lens of the first monocular camera 204L and a lens of the second monocular camera 204R. The three-dimensional display device 90 displays an image of the virtual external environment on the basis of the image information output from the simulator device 80. As illustrated in FIG. 4A to FIG. 4C, the three-dimensional display device 90 includes a monitor 92 and an optical filter 94. The monitor 92 is disposed so as to face the lens of the first monocular camera 204L and the second monocular camera 204R, and displays the image information of the virtual external environment output from the simulator device 80, as a first image and a second image in the same screen. The optical filter 94 is disposed between the monitor 92, and the first monocular camera 204L and the second monocular camera 204R. The optical filter 94 outputs, from among light of the images output from the monitor 92, light 96L of the first image to the first monocular camera 204L, and light 96R of the second image to the second monocular camera 204R.

As illustrated in FIG. 4A and FIG. 4B, the three-dimensional display device 90 may be disposed in a manner that a parallax barrier 94a or a lenticular lens 94b covers the monitor 92. Moreover, as illustrated in FIG. 4C, the three-dimensional display device 90 may be disposed in a manner that a polarizing filter 94c formed by a linear polarizing filter or a circular polarizing filter covers each of the lens of the first monocular camera 204L and the lens of the second monocular camera 204R. In addition, various other methods that can display, in the same screen, the image including the first image simulating the external environment toward the first monocular camera 204L and the second image simulating the external environment toward the second monocular camera 204R can be employed. Examples of such methods include an anaglyph method in which red and blue filters are used, and a liquid crystal shutter method in which a field of vision of each camera is blocked alternately.

The three-dimensional display device 90 is fixed at a constant position with respect to the bench test machine 20. That is to say, the three-dimensional display device 90 is disposed at a fixed position with respect to the bench test machine 20. The constant position and the fixed position refer to a position where the three-dimensional display device 90 is disposed face-to-face with the camera group 204 in a state that each wheel 220 of the vehicle 200 is placed at the center of the corresponding roller 42 in the axial direction thereof (vehicle width direction). More specifically, the constant position and the fixed position refer to a position where the distance from the center of the screen of the three-dimensional display device 90 to the lens of the first monocular camera 204L is equal to the distance from the center of the screen of the three-dimensional display device 90 to the lens of the second monocular camera 204R, and the photographing ranges of the first monocular camera 204L and the second monocular camera 204R fall within the screen of the three-dimensional display device 90. Note that the position of the three-dimensional display device 90 in the up-down direction may be variable while the position thereof in the left-right direction (vehicle width direction) is fixed. In this case, after the vehicle 200 advances to the bench test machine 20, the position of the three-dimensional display device 90 is adjusted in the up-down direction.

### [2.4. Target Device 100]

The target device 100 is disposed to face the radar 206 and the LiDAR 208. The target device 100 includes a target 102, a guide rail 104, and an electric motor 106. The target 102 is a plate material simulating a preceding vehicle, for example. By the operation of the electric motor 106, the target 102 can be moved in a direction of approaching or separating from the front side of the vehicle 200 along the guide rail 104. The electric motor 106 operates in accordance with the electric power output from the simulator device 80.

Note that the radar 206 and the LiDAR 208 may detect a virtual target instead of detecting the target 102 representing the preceding vehicle. In this case, the electric wave from the radar 206 and the laser light from the LiDAR 208 may be absorbed and a quasi-reflection wave may be delivered to the radar 206 and the LiDAR 208 at the timing in accordance with the distance to the virtual preceding vehicle.

### [2.5. Analysis Device 110]

The analysis device 110 is formed by a computer including a processor, a storage device, and an input/output device. The analysis device 110 acquires a data log of the inspection from the simulator device 80 or the bench test machine 20, here the information in time series about the vehicle speed V and the steering angle θs of the vehicle 200.

### 3. Operation Inspection Procedure of Vehicle 200 and Operation of Each Part

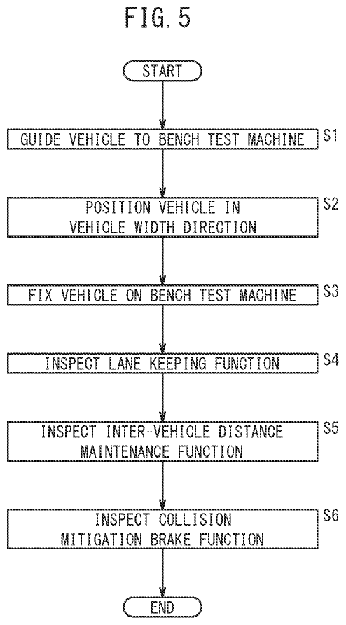

With reference to FIG. 5, the procedure of the operation inspection of the vehicle 200 using the vehicle inspection system 10 and the operation of each part are described. The inspection is performed in the order of step S1 to step S6 in FIG. 5. Here, it is assumed that the lane keeping function, the inter-vehicle distance maintenance function, and the collision mitigation brake function are inspected. The following inspection is performed with an operator in the vehicle 200.

In step S1, the vehicle 200 is guided to the bench test machine 20. Here, the front wheel 220f is placed on the rollers 42 in the roller unit 22, and the rear wheel 220r is placed on the rollers 42 in the roller device 24.

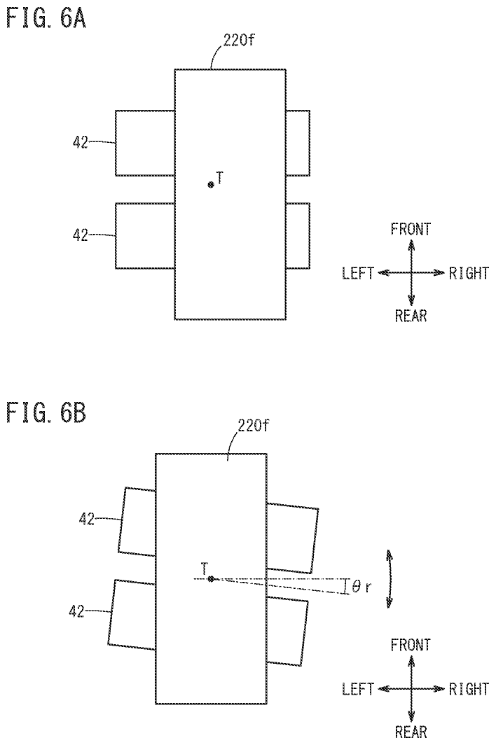

In step S2, positioning of the vehicle 200 in the vehicle width direction is performed. In the present embodiment, the operation of the vehicle 200 is inspected in a state where each wheel 220 is placed at the center of the corresponding roller 42 in the axial direction (vehicle width direction). As such, it is necessary to place each wheel 220 at a correct position, for example at the center of each roller 42 in the axial direction thereof (hereinafter this position will be also simply referred to as “center of rollers 42”) before the vehicle 200 is caused to travel on the bench test machine 20. Here, description will be given of a method in which, assuming that the front wheel 220f of the vehicle 200 is displaced to the right with respect to the roller unit 22, the position of the front wheel 220f is adjusted to the center of the rollers 42 as illustrated in FIG. 6A.

The test bench storage device 76 stores in advance a distance Ds from the vehicle position sensor 32 to a predetermined portion of the front wheel 220f and a threshold Dth corresponding to allowable deviation in an initial state (a state where the front wheel 220f is at the center of the rollers 42 and the steering angle θs is zero).

The test bench calculation device 74 compares the latest distance D detected by the vehicle position sensor 32 with the distance Ds, and keeps operating the turning motor 60 of the roller unit 22 until the difference between the both (=|D−Ds|) becomes the threshold Dth or less, preferably until the both coincide with each other. At this time, the test bench input/output device 78 outputs an electric power determined by the test bench calculation device 74.

The turning motor 60 receives the electric power output from the test bench input/output device 78, and repeats rotation of a predetermined angle in a positive direction and a negative direction. Then, as illustrated in FIG. 6B, the rollers 42 of the roller unit 22 are turned around the turning axis T alternately in the positive direction and the negative direction by a predetermined angle θr with a reference posture (a posture at which the axial direction of the rollers 42 coincides with the vehicle width direction) as a starting point. As the rollers 42 are turned, a reaction force occurs in the front wheel 220f in a direction of the turning axis T. Then, the front wheel 220f moves to the center of the rollers 42 (in this case, to the left) by the reaction force without the steering angle θs remaining unchanged. Moreover, the vehicle 200 moves to the center of the bench test machine 20 (in this case, to the left). The turning operation of the rollers 42 is repeated and when the difference between the distance D and the distance Ds becomes the threshold Dth or less, the test bench calculation device 74 stops the operation of the turning motor 60. At this time, the test bench input/output device 78 stops the output of control electric power. The rollers 42 stop at a position where the rollers 42 are orthogonal to the front wheel 220f.

The method in which the front wheel 220f that is shifted to the right is moved to the center of the rollers 42 has been described with reference to FIG. 6A and FIG. 6B. Similarly, the front wheel 220f that is shifted to the left can be moved to the center of the rollers 42. At this time, the first monocular camera 204L and the second monocular camera 204R, and the three-dimensional display device 90 may be disposed to face each other by slightly displacing the image in the left-right direction, instead of moving the three-dimensional display device 90 in the left-right direction.

In step S3, the vehicle 200 is fixed onto the bench test machine 20. In a state where positioning of the vehicle 200 in the vehicle width direction has been completed in step S2, the convex part 72 of the movement restriction device 26 is positioned right below the jack-up point 224 of the vehicle 200. The test bench calculation device 74 operates the movement restriction device 26 and the height adjustment device 58 of the roller unit 22 in a state where the difference between the distance D and the distance Ds is the threshold Dth or less. At this time, the test bench input/output device 78 outputs a pilot signal to the movement restriction device 26 and the height adjustment device 58.

The protrusion quantity adjustment device 70 lifts up the convex part 72 in accordance with the pilot signal output from the test bench input/output device 78. The convex part 72 is brought into contact with the jack-up point 224 of the vehicle 200.

The height adjustment device 58 operates the solenoid valve in accordance with the pilot signal output from the test bench input/output device 78, so that fluid is discharged from the cylinder 52. Then, the rollers 42 of the roller unit 22 go down and the front wheel 220f goes down accordingly. At this time, since the convex part 72 of the movement restriction device 26 is in contact with the jack-up point 224 of the vehicle 200, the suspension of the vehicle 200 is extended and only the front wheel 220f goes down. As a result, the movement of the vehicle 200 in the vehicle width direction and a front-rear direction is restricted, and the vehicle 200 is secured on the bench test machine 20. At this time, the vertical positions of the three-dimensional display device 90, the first monocular camera 204L, and the second monocular camera 204R remain unchanged.

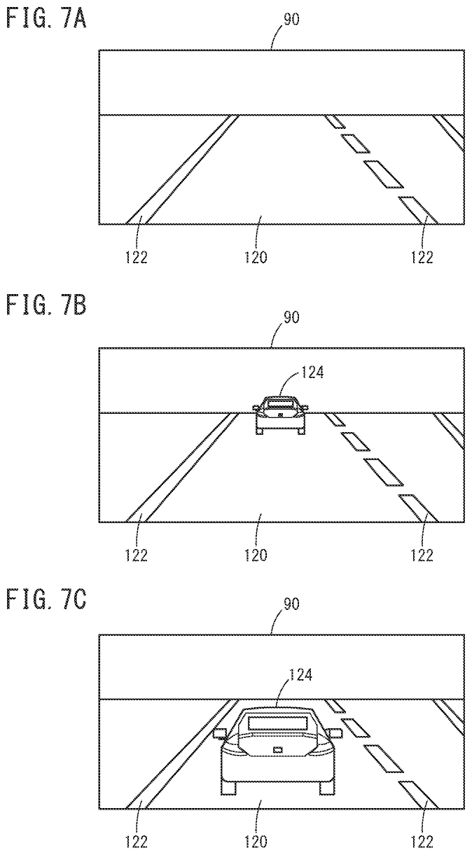

In step S4, the lane keeping function is inspected. In the inspection of the lane keeping function, the simulator device 80 reproduces the virtual external environment showing a scene without any obstacle (FIG. 7A). The simulator calculation device 82 reproduces a traveling scene without any obstacle on the basis of the virtual external environment information 88, and causes the three-dimensional display device 90 to display an image of the reproduced scene (the first image and the second image). As illustrated in FIG. 7A, the three-dimensional display device 90 displays, as the virtual external environment, a driving lane 120 where left and right compartment lines 122 are provided. The first monocular camera 204L in the vehicle 200 photographs the first image displayed on the three-dimensional display device 90, and the second monocular camera 204R photographs the second image displayed on the three-dimensional display device 90. On the other hand, the radar 206 and the LiDAR 208 are covered with an electromagnetic wave absorber (not illustrated), and the virtual external environment without any obstacle, that is, an environment without reflection of the electromagnetic wave is reproduced.

The operator operates a switch in advance so as to activate the lane keeping function. The vehicle control device 210 performs acceleration/deceleration control in accordance with the operator's operation on the accelerator pedal or the brake pedal, and additionally performs steering control so that the vehicle 200 travels at the center of the driving lane 120 on the basis of a detection result from the external environment sensors 202.

The simulator calculation device 82 calculates the movement quantity and the direction of the vehicle 200 on the basis of the vehicle speed V detected by the vehicle speed sensor 28 and the steering angle θs detected by the wheel position sensor 30. Then, the simulator calculation device 82 changes the position of the vehicle 200 in the virtual external environment in accordance with the calculated movement quantity and direction, and reproduces the virtual external environment around the changed position. The three-dimensional display device 90 displays the image of the latest virtual external environment reproduced by the simulator calculation device 82. As a result, the image displayed on the three-dimensional display device 90 is synchronized with the operation of the vehicle 200. Similarly, in the inspection in step S5 and step S6 to be described below, the simulator calculation device 82 causes the three-dimensional display device 90 to display the image in synchronization with the operation of the vehicle 200.

The test bench control device 34 operates the turning motor 60 of the roller unit 22 on the basis of the steering angle θs detected by the wheel position sensor 30, in order to turn the rollers 42 in the roller unit 22 so as to follow up the steering of the front wheel 220f. Thus, the test bench control device 34 keeps the rollers 42 orthogonal to the front wheel 220f (i.e., keeping the rotation axis R of the rollers 42 parallel to the axle of the front wheel 220f). Similarly in the inspection in step S5 and step S6 to be described below, the test bench control device 34 operates the turning motor 60 of the roller unit 22. In addition, at this time, the convex part 72 is in contact with the jack-up point 224, so that the vehicle 200 is supported and firmly positioned in place. Thus, the relative position between the three-dimensional display device 90 and the first monocular camera 204L and the relative position between the three-dimensional display device 90 and the second monocular camera 204R are maintained, and thus the first monocular camera 204L and the second monocular camera 204R are always face-to-face with the three-dimensional display device 90.

In step S5, the inter-vehicle distance maintenance function is inspected. In the inspection of the inter-vehicle distance maintenance function, the simulator device 80 reproduces the virtual external environment showing a scene where a preceding vehicle 124 (FIG. 7B) travels. The simulator calculation device 82 reproduces the scene where the preceding vehicle 124 travels, on the basis of the virtual external environment information 88, and causes the three-dimensional display device 90 to display the image of the reproduced scene (the first image and the second image). As illustrated in FIG. 7B, the three-dimensional display device 90 displays, as the virtual external environment, the preceding vehicle 124 traveling a predetermined distance ahead of the virtual traveling position of the vehicle 200 together with the driving lane 120. The first monocular camera 204L in the vehicle 200 photographs the first image displayed on the three-dimensional display device 90, and the second monocular camera 204R photographs the second image displayed on the three-dimensional display device 90.

In addition, the simulator calculation device 82 controls the operation of the electric motor 106 such that the position of the target 102 coincides with the position of the preceding vehicle 124 in the virtual external environment information 88. The electric motor 106 of the target device 100 operates with electric power output from the simulator input/output device 86, and moves the target 102 to the position of the preceding vehicle 124 in the virtual external environment. The radar 206 and the LiDAR 208 of the vehicle 200 detect the target 102.

The operator operates a switch in advance so as to activate the inter-vehicle distance maintenance function. The vehicle control device 210 performs the steering control in accordance with the operator's operation of the steering wheel, and additionally performs the acceleration/deceleration control such that the vehicle 200 travels while maintaining the inter-vehicle distance between the vehicle 200 and the preceding vehicle 124 on the basis of the detection result from the external environment sensors 202. In addition, at this time, the convex part 72 is in contact with the jack-up point 224, whereby the vehicle 200 is supported and secured in place. Thus, the relative position between the three-dimensional display device 90 and the first monocular camera 204L and the relative position between the three-dimensional display device 90 and the second monocular camera 204R are maintained, and the first monocular camera 204L and the second monocular camera 204R are always positioned face-to-face with the three-dimensional display device 90.

In step S6, the collision mitigation brake function is inspected. In the inspection of the collision mitigation brake function, the simulator device 80 reproduces the virtual external environment showing a scene where the preceding vehicle 124 suddenly stops (FIG. 7C). The simulator calculation device 82 reproduces the scene where the preceding vehicle 124 suddenly stops on the basis of the virtual external environment information 88, and causes the three-dimensional display device 90 to display the image of the reproduced scene (the first image and the second image). As illustrated in FIG. 7C, the three-dimensional display device 90 displays, as the virtual external environment, the preceding vehicle 124 that stops suddenly ahead of the vehicle 200, that is, the preceding vehicle 124 that rapidly approaches the vehicle 200, together with the driving lane 120. The first monocular camera 204L in the vehicle 200 photographs the first image displayed on the three-dimensional display device 90, and the second monocular camera 204R photographs the second image displayed on the three-dimensional display device 90.

The simulator calculation device 82 controls the operation of the electric motor 106 such that the position of the target 102 coincides with the position of the preceding vehicle 124 in the virtual external environment information 88. The electric motor 106 of the target device 100 operates with electric power output from the simulator input/output device 86, and causes the target 102 to rapidly approach the vehicle 200. The radar 206 and the LiDAR 208 of the vehicle 200 detect the target 102.

In the inspection of the collision mitigation brake function, the operator does not perform the operation of the brake pedal. In addition, at this time, the convex part 72 is in contact with the jack-up point 224, whereby the vehicle 200 is supported and fixed in place. Thus, the relative position between the three-dimensional display device 90 and the first monocular camera 204L and the relative position between the three-dimensional display device 90 and the second monocular camera 204R are held, and the first monocular camera 204L and the second monocular camera 204R are always face-to-face with the three-dimensional display device 90.

When the reproduction of the predetermined virtual external environment ends, the simulator device 80 outputs an end signal to the test bench control device 34. Upon the input of the end signal, the test bench input/output device 78 outputs the pilot signal to the roller unit 22. The height adjustment device 58 operates the solenoid valve in accordance with the pilot signal output from the test bench input/output device 78, and supplies the fluid to the cylinder 52. Then, the rollers 42 in the roller unit 22 go up and the vehicle 200 goes up. At this time, the convex part 72 of the movement restriction device 26 is separated from the jack-up point 224 of the vehicle 200. As a result, the movement restriction of the vehicle 200 in the vehicle width direction and the front-rear direction is canceled.

After the inspection ends, the analysis device 110 analyzes the data log. For example, the data indicating the operation model of the vehicle 200 for the reproduced virtual external environment and the data log that is obtained actually are compared. If the difference between the both is within the allowable range, it is possible to determine that the external environment sensors 202, the vehicle control device 210, the driving device 212, the steering device 214, and the braking device 216 of the vehicle 200 are normal.

### 4. Advantage of Using Three-Dimensional Display Device 90

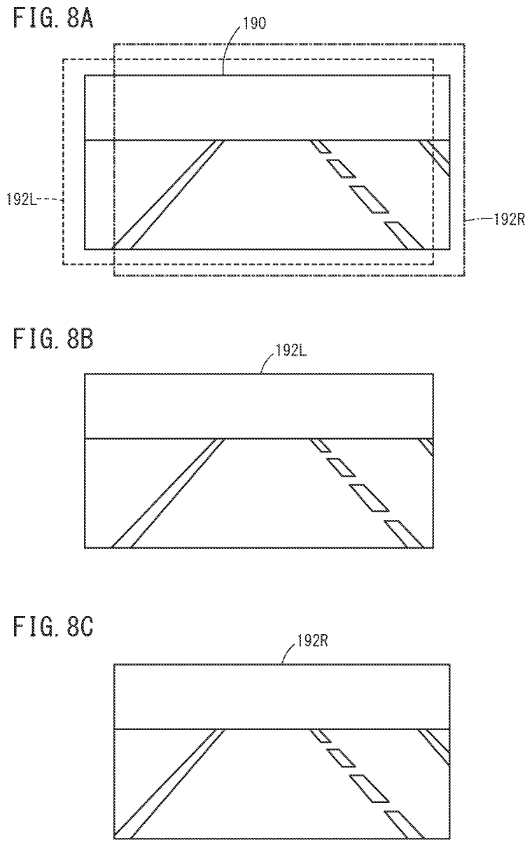

The advantages of the three-dimensional display device 90 are described with reference to FIG. 8A to 8C. There is parallax between the first monocular camera 204L and the second monocular camera 204R. When the external environment is photographed actually, the parallax is not a problem because the external environment to be detected is sufficiently far from the first monocular camera 204L and the second monocular camera 204R. On the other hand, in a case where the virtual external environment is photographed by the first monocular camera 204L and the second monocular camera 204R with the use of the display device, the display device is brought close to the first monocular camera 204L and the second monocular camera 204R in order to cause the first monocular camera 204L and the second monocular camera 204R to photograph only the screen of the display device. As a result, the influence of the parallax between the first monocular camera 204L and the second monocular camera 204R is large.

For example, it is assumed that a two-dimensional display device 190 is photographed by the first monocular camera 204L and the second monocular camera 204R as illustrated in FIG. 8A. In this case, as illustrated in FIG. 8B, the first monocular camera 204L that is disposed on the left side photographs a left-side screen 192L of the two-dimensional display device 190. Moreover, as illustrated in FIG. 8C, the second monocular camera 204R that is disposed on the right side photographs a right-side screen 192R of the two-dimensional display device 190. As a result, the difference between the image information photographed by the first monocular camera 204L and the image information photographed by the second monocular camera 204R is large. If the difference between the two pieces of image information is large, the vehicle control device 210 determines that the reliability of the image information is low, and stops the control regarding image recognition.

As described above in the present embodiment, displaying the first image and the second image on the three-dimensional display device 90 can prevent the difference between the image information of the first monocular camera 204L and the image information of the second monocular camera 204R even when the three-dimensional display device 90 is brought close to the first monocular camera 204L and the second monocular camera 204R. That is to say, various functions of the vehicle 200 on the basis of the image information from the first monocular camera 204L and the second monocular camera 204R can be inspected by photographing the virtual external environment. Thus, the space saving can be achieved.

### 5. Modification

The vehicle 200 may be connected to a data reader (not illustrated). The data reader can display on the screen the content of the operation instruction from the vehicle control device 210 and the detection information from the external environment sensors 202. The detection information from the external environment sensors 202 and the operation instruction information from the vehicle control device 210 can be inspected by the data reader.

As described above, the vehicle 200 may be an automated driving vehicle. In this case, the simulator device 80 transmits a quasi-signal indicating the positional information of the vehicle 200 in the virtual external environment to the GNSS receiver in the vehicle 200.

The function other than the lane keeping function, the inter-vehicle distance maintenance function, and the collision mitigation brake function described above can also be inspected. For example, a function of preventing departure from a road or an anti-lock brake function can also be inspected.

In each inspection, the torque motor 44 may apply a load according to the virtual external environment to the front wheel 220f, which is the driving wheel, in order to make the travel state closer to the actual travel state. In addition, when an upper end of the convex part 72 and an upper surface of the jack-up point 224 are in contact and the convex part 72 supports a part of the weight of the vehicle 200, the pressing force between the front wheel 220f and the rollers 42 decreases and in the worst case, the front wheel 220f slips. In order to prevent the front wheel 220f from slipping, the torque motor 44 may apply a load to the front wheel 220f.

In the above embodiment, the bench test machine 20 for inspecting the vehicle 200 whose front wheel 220f is the driving wheel has been described. On the other hand, in a case of inspecting the vehicle 200 whose rear wheel 220r is the driving wheel, the vehicle speed sensor 28 detects the rotation speed r of any of the rollers 42 in the roller device 24 that supports the rear wheel 220r.

In the aforementioned embodiment, the front wheel 220f is moved to the center of the rollers 42 by turning the rollers 42, and thus the relative position between the first monocular camera 204L and the second monocular camera 204R, and the three-dimensional display device 90 is kept constant. Alternatively, the roller unit 22 and the roller device 24 may slide in the vehicle width direction so that the displacement of the vehicle 200 is solved.

Moreover, as the three-dimensional display device 90, a display device in which a three-dimensional image is projected on the screen by a projector may be used instead of the monitor 92 and the optical filter 94.

In the above description, the vehicle 200 includes the two monocular cameras that perform photographing in the same direction. However, the vehicle 200 may include two or more monocular cameras. In this case, by combining the above plural kinds of the three-dimensional display devices 90 (for example, anaglyph method and polarizing method), all the monocular cameras may photograph the same external environment in the same screen.

### 6. Technical Concept Obtained from Embodiment

The technical concept that is obtained from the above embodiment and the modifications is hereinafter described.

The present invention provides the vehicle inspection system 10 configured to inspect the vehicle 200 that performs the travel control on the basis of the information about the external environment in the predetermined direction, detected by the first monocular camera 204L and the second monocular camera 204R, the vehicle inspection system 10 including the three-dimensional display device 90 configured to display the first image simulating the external environment toward the first monocular camera 204L, display the second image simulating the external environment toward the second monocular camera 204R, and moreover display the first image and the second image in the same screen.

For example, there are vehicles 200 in which the two monocular cameras that are arranged adjacent to each other photograph the external environment in the same direction in order to achieve the redundancy or the like. The aforementioned configuration is an inspection system to inspect such vehicles 200.

In the above configuration, by using the three-dimensional display device 90, images simulating various external environments can be displayed toward the first monocular camera 204L and the second monocular camera 204R of the vehicle 200. Thus, various functions of the vehicle 200 on the basis of image information can be inspected. For example, since the three-dimensional display device 90 displays the driving lane 120 and the compartment lines 122, the lane keeping function can be inspected. Moreover, the three-dimensional display device 90 displays the preceding vehicle 124, whereby the inter-vehicle distance maintenance function can be inspected. Furthermore, the operation instruction on the basis of image information is monitored, the first monocular camera 204L, the second monocular camera 204R, and the vehicle control device 210 can be inspected with space saved.

In addition, in the above configuration, by using the three-dimensional display device 90, the influence of the parallax between the cameras can be reduced even if the three-dimensional display device 90 is disposed near the first monocular camera 204L and the second monocular camera 204R. That is to say, concerning the first monocular camera 204L and the second monocular camera 204R, the difference between the first image from the first monocular camera 204L and the second image from the second monocular camera 204R can be more reduced by displaying the image by the three-dimensional display device 90, compared with a case of displaying the image by the two-dimensional display device 190. Thus, the vehicle control device 210 can be inspected with space saved.

In the present invention, the three-dimensional display device 90 may include the monitor 92 configured to display the first image and the second image in the same screen, and the optical filter 94 disposed so as to cover the monitor 92 and configured to output the light 96L of the first image from the monitor 92 to the first monocular camera 204L and output the light 96R of the second image from the monitor 92 to the second monocular camera 204R.

In the present invention, the three-dimensional display device 90 may include the monitor 92 configured to display the first image and the second image in the same screen, and the optical filter 94 disposed so as to cover the lens of the first monocular camera 204L and the lens of the second monocular camera 204R and configured to output the light 96L of the first image from the monitor 92 to the first monocular camera 204L and output the light 96R of the second image from the monitor 92 to the second monocular camera 204R.

In the present invention, the vehicle inspection system 10 may further include: the bench test machine 20 configured to rotatably support the wheels 220 of the vehicle 200 by the rollers 42 provided for each wheel 220; the sensor (vehicle speed sensor 28, wheel position sensor 30) configured to detect the operation of the vehicle 200; and the simulator device 80 configured to change the first image and the second image displayed on the three-dimensional display device 90, on the basis of the detection result from the sensor (vehicle speed sensor 28, wheel position sensor 30).

Note that the vehicle inspection system according to the present invention is not limited to the aforementioned embodiment, and various configurations can be employed without departing from the essence and gist of the present invention.

What is claim is:

1. A vehicle inspection system configured to inspect a vehicle that performs travel control on a basis of information about an external environment in a predetermined direction, detected by a first monocular camera and a second monocular camera, the vehicle inspection system comprising a three-dimensional display device configured to display a first image simulating the external environment toward the first monocular camera, display a second image simulating the external environment toward the second monocular camera, and moreover display the first image and the second image in a same screen.

2. The vehicle inspection system according to claim 1, wherein the three-dimensional display device includes:
a monitor configured to display the first image and the second image in the same screen; and
an optical filter disposed so as to cover the monitor and configured to output light of the first image from the monitor to the first monocular camera and output light of the second image from the monitor to the second monocular camera.

3. The vehicle inspection system according to claim 1, wherein the three-dimensional display device includes:
a monitor configured to display the first image and the second image in the same screen; and
an optical filter disposed so as to cover a lens of the first monocular camera and a lens of the second monocular camera and configured to output light of the first image from the monitor to the first monocular camera and output light of the second image from the monitor to the second monocular camera.

4. The vehicle inspection system according to claim 1, further comprising:
a bench test machine configured to rotatably support wheels of the vehicle by rollers provided for each wheel;
a sensor configured to detect operation of the vehicle; and
a simulator device configured to change the first image and the second image displayed on the three-dimensional display device, based on a detection result from the sensor.
